(19) United States
(12) Patent Application Publication
(10) Pub. No.: US 2021/0218318 A1
(43) Pub. Date: Jul. 15, 2021

(54) MONITORING AT LEAST ONE ELECTRIC MOTOR

(71) Applicant: ebm-papst Mulfingen GmbH & Co. KG, Mulfingen (DE)

(72) Inventors: Malte PILS, Ilshofen-Oberaspach (DE); Alex SCHNEIDER, Kuenzelsau (DE)

(21) Appl. No.: 17/058,959

(22) PCT Filed: Jul. 1, 2019
(86) PCT No.: PCT/EP2019/067626

§ 371 Date: Nov. 25, 2020

(30) Foreign Application Priority Data
Jul. 17, 2018 (DE) 10 2018 117 262.1

(51) Int. Cl. H02K 11/25; H02P 29/60; H02P 23/14

(52) U.S. Cl. CPC H02K 11/25; H02P 23/14; H02P 29/60

(57) ABSTRACT

The invention relates to a method for monitoring at least the motor temperature as a motor parameter during operation of at least one electric motor (1) at power electronics (2), having the following steps: acquiring electrical motor variables by measurement with a measuring device (3); creating a parameter file (6) containing motor parameters (4) using the measured motor variables, or reading the motor parameters (4) out of a data store (7), wherein a controller (5) controls the electric motor (1) with regard to at least the temperature as a motor parameter, using the further motor parameters (4) from the parameter file (6).

The invention relates to a method and a system for monitoring at least the motor temperature as a motor parameter during operation of at least one electric motor at power electronics.

From DE102014005706 A1 and DE10119201A1 it is known that various methods determine electrical parameters of an electric motor using direct or indirect measures. Based on the information collected, the thermal or electric models of the methods are calibrated and completed so that the motor temperature is able to be determined at a standstill or during operation. This way, the motor can be protected against potential overheating by changing the operating point of the motor by intervening in open/closed-loop control and by changing target values such that the motor can cool down or commutation can be interrupted completely if the motor temperature continues to rise.

The disadvantage of these methods is that the assessments only consider the motor temperatures as such. Further, they result in reduced functional safety as an incorrect parameterization of operating points which is not suitable or in any case not optimal for the corresponding motor leads to the motor only being switched off in the event of thermal overload. Moreover, incorrect parameterization of the operating characteristics of the electric motor will result in an increased effort involved in troubleshooting in the event of failure or damage.

Therefore, the object of the present invention is to overcome the aforementioned shortcomings and provide a system and a method for monitoring at least the motor temperature as a motor parameter during operation of at least one electric motor at power electronics, also enabling, in addition to the electrical parameters for the calibration and completion of motor temperature acquisition, the assignment or determination of suitable motor operating parameters.

This object is achieved by the combination of features according to claim 1.

Hence, according to the invention, a method is proposed for monitoring at least the motor temperature as a motor parameter when operating at least one electric motor at power electronics, which acquires electrical motor variables by measurement with a measuring device, and creates a parameter file containing motor parameters using the measured motor variables, or reading the motor parameters from a data store. In this process, a controller controls the electric motor with regard to at least the temperature as a motor parameter, using the further motor parameters from the parameter file. As such, it is beneficial that additional motor parameters are acquired and stored in the form of the parameter file. This means operating points which already occurred can be controlled in an optimal manner and critical areas can be identified at an early stage. This results in an extended service life of components to be commutated by avoiding overload. It is also advantageous that the method runs parallel to temperature determination.

In an advantageous embodiment variant, it is provided that the respective further motor parameters of the relevant electric motor are the speed, the motor voltage, the amperage and/or an output of the motor. As these specific motor parameters have the essential influence on temperature development during operation of the electric motor, the monitoring these characteristic values optimizes the temperature-dependent control of the electric motor.

In one exemplary embodiment of the invention, it is provided that the measuring device and the controller of the electric motor(s) are contained in the power electronics or connected between the power electronics and the electric motor. As such, it is advantageous if the optimal connection can be selected flexibly depending on the application.

Further, an implementation is beneficial in which the power electronics and the measuring device as well as the controller are arranged centrally on a common printed circuit board. The advantage of this is that the number of components can be reduced considerably, significantly reducing assembly and maintenance work.

In another advantageous variant it is provided, according to the invention, that the power electronics and the measuring device as well as the controller are arranged to be wholly or partly integrated in the electric motor unit of the respective electric motor—i.e., distributed. This way, control of multiple electric motors operated independently of each other is considerably simplified as the power electronics merely need to refer to the parameters of the relevant electric motor.

In one embodiment variant, the method according to the invention is adapted such that the at least one electric motor is designed as a fan or compressor. This makes the method suitable for several applications, thus increasing possible uses.

Furthermore, it is advantageous if a winding resistance and/or winding inductance are determined for the respective electric motor from the motor parameters determined and, based on the respective winding resistance and/or winding inductance, the electric motor configuration is accomplished by means of stored parameter maps or using a stored computing algorithm. This results in increased functional safety.

In a preferred embodiment of the invention, the motor parameters determined are further employed for stored motor or temperature models which are incorporated into the control of the respective electric motor.

The method of the invention preferably enables targeted performance of a fault assessment in the event of failure or in the event of damage based on the motor parameters or parameter file, wherein any parameters acquired can be directly or indirectly incorporated into the assessment. This results in the fault assessment being optimized as the critical motor parameters can be identified accurately in the event of damage.

Preferably, a system according to the invention comprises at least two electric motors for monitoring at least the motor temperature as a motor parameter during operation of the electric motors, the power electronics with a DC link, and a DC link voltage applied to a DC link capacitor for supplying the electric motors. As such, each electric motor has an output stage and an EMC filter, and the power electronics and the measuring device as well as the controller are arranged centrally on a common printed circuit board.

In another advantageous variant, it is provided, according to the invention, that the system comprises at least two electric motors for monitoring at least the motor temperature as a motor parameter during operation of the electric motors, the power electronics with a DC link, and a DC link voltage applied to a DC link capacitor for supplying the electric motors. As such, each electric motor has an output stage and an EMC filter, and the power electronics and the measuring device as well as the controller are arranged to be wholly or partly integrated in the electric motor unit for each electric motor.

Other advantageous further developments of the invention are characterized in the dependent claims or are presented in detail below along with the description of the preferred implementation of the invention with reference to the figures. In the drawings:

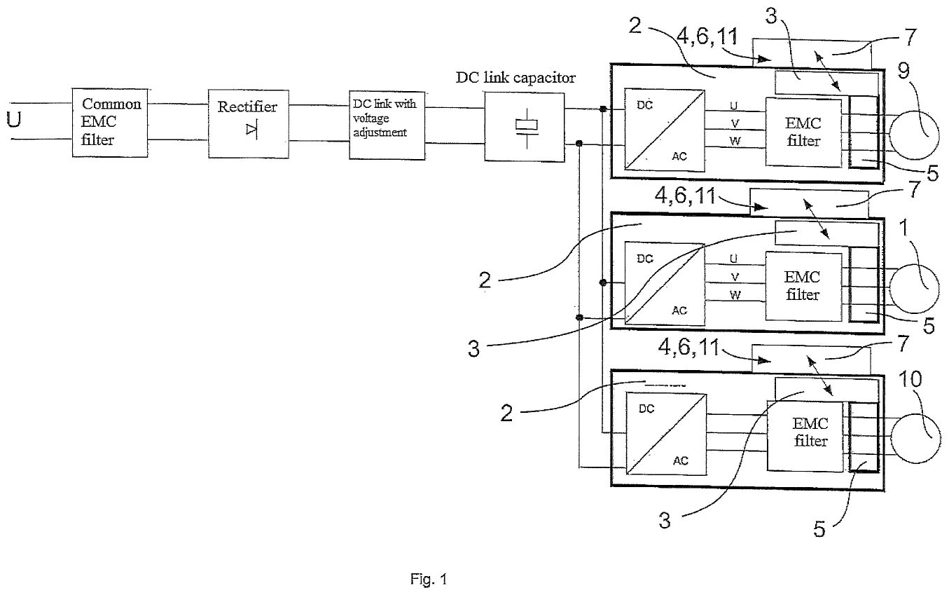

FIG. 1 shows a system arrangement for the method, having three electric motors each with an integrated power or measuring device,

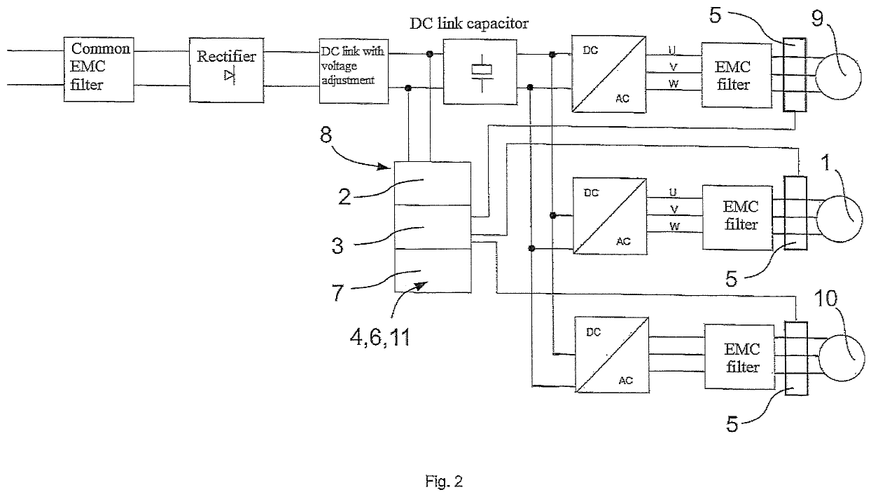

FIG. 2 shows a system arrangement for the method, having three electric motors with a central power or measuring device on a printed circuit board.

FIG. 1 shows a system arrangement for the method, having an electric motor 1, a fan 9, and a compressor 10 with a wholly or partly integrated power and/or measuring device 2, 3. Each of these electric motors 1, 9, 10 has separate power electronics 2. Power electronics 2 are connected to a DC link and a DC link voltage applied to a DC link capacitor for supplying electric motors 1. As such, each electric motor 1 has a DC/AC output stage and an EMC filter arranged in power electronics 2 as are measuring device 3 and controller 4 of electric motors 1. Power electronics 2 and measuring device 3 as well as controller 4 are arranged to be integrated in the electric motor unit.

The electrical motor variables are acquired by measurement with measuring device 3, and a parameter file 6 containing motor parameters 4 is created using the measured motor variables, or the corresponding motor parameters 4 are read from data store 7.

Further, controller 5 controls electric motor 1 with regard to at least the temperature as a motor parameter, using the further motor parameters 4 from parameter file 6 or parameter maps 11.

FIG. 2 shows a system arrangement for applying the method according to the invention, having an electric motor 1, a fan 9, and a compressor 10 with a central power 2 and/or measuring device 3. As such, the system layout only differs in that power electronics 2, measuring device 3 and data store 7 are arranged on a common printed circuit board 8. In any other respect, reference is made to FIG. 1 as far as reference numerals are concerned to avoid repetitions.

The practice of the invention is not limited to the preferred exemplary embodiments set forth above. Instead, a number of variants may be contemplated which use the presented solution also in case of basically different embodiments.

1. A method for monitoring at least the motor temperature as a motor parameter during operation of at least one electric motor (1) at power electronics (2), having the following steps:
a. acquiring electrical motor variables by measurement with a measuring device (3);
b. creating a parameter file (6) containing motor parameters (4) using the measured motor variables, or reading the motor parameters (4) out of a data store (7),
wherein a controller (5) controls the electric motor (1) with regard to at least the temperature as a motor parameter, using the further motor parameters (4) from the parameter file (6).

2. The method for monitoring at least the motor temperature as a motor parameter during operation of at least one electric motor (1) according to claim 1, characterized in that the respective further motor parameters (4) of the corresponding electric motor (1) are the speed, the motor voltage, the amperage and/or an output of the motor.

3. The method for monitoring at least the motor temperature as a motor parameter during operation of at least one electric motor (1) according to claim 1, characterized in that the measuring device (3) and the controller (5) of the electric motor(s) (1) are located in the power electronics (2) or connected between the power electronics (2) and the electric motor (1).

4. The method for monitoring at least the motor temperature as a motor parameter during operation of at least one electric motor (1) according to claim 1, characterized in that the power electronics (2) and the measuring device (3) as well as the controller (5) are arranged centrally on a common printed circuit board (8).

5. The method for monitoring at least the motor temperature as a motor parameter during operation of at least one electric motor (1) according to claim 1, characterized in that the power electronics (2) and the measuring device (3) as well as the controller (5) are arranged to be wholly or partly integrated in the electric motor unit.

6. The method for monitoring at least the motor temperature as a motor parameter during operation of at least one electric motor (1) according to claim 1, characterized in that the at least one electric motor (1) is designed as a fan (9) or a compressor (10).

7. The method for monitoring at least the motor temperature as a motor parameter during operation of at least one electric motor (1) according to claim 1, characterized in that a winding resistance and/or winding inductance are determined for the respective electric motor (1) from the motor parameters (4) determined and, based on the respective winding resistance and/or winding inductance, the electric motor configuration is accomplished by means of stored parameter maps (11) or using a stored computing algorithm.

8. The method for monitoring at least the motor temperature as a motor parameter during operation of at least one electric motor (1) according to claim 1, characterized in that the motor parameters (4) determined are further employed for stored motor or temperature models which are incorporated into the control of the respective electric motor (1).

9. The method for monitoring at least the motor temperature as a motor parameter during operation of at least one electric motor (1) according to claim 1, characterized in that a fault assessment is performed in the event of a failure or in the event of damage based on the motor parameters (4) or the parameter file (6).

10. A system, having at least two electric motors (1) for monitoring at least the motor temperature as a motor parameter during operation of the electric motor (1) according to claim 1, the system comprising:
a. power electronics (2) with a DC link and a DC link voltage applied to a DC link capacitor for supplying the electric motors;
b. wherein each electric motor has an output stages and an EMC filter, and the power electronics (2) and the measuring device (3) as well as the controller (5) are arranged centrally on a common printed circuit board (8).

11. A system, having at least two electric motors (1) for monitoring at least the motor temperature as a motor parameter during operation of the electric motor (1) according to claim 1, the system comprising:
a. power electronics (2) with a DC link and a DC link voltage applied to a DC link capacitor for supplying the electric motors;
b. wherein each electric motor has an output stages and an EMC filter, and the power electronics (2) and the measuring device (3) as well as the controller (5) are arranged to be wholly or partly integrated in a respective electric motor unit of the electric motor (1).
